(19) United States
(12) Patent Application Publication
(10) Pub. No.: US 2014/0057057 A1
(43) Pub. Date: Feb. 27, 2014

(54) PROCESS FOR PRODUCING A LAMINATED POROUS FILM

(71) Applicant: MITSUBISHI PLASTICS, INC., Tokyo (JP)

(72) Inventors: Tomohiko Terai, Nagoya-shi (JP); Satoru Momohira, Nagoya-shi (JP); Hirotaka Aria, Nagoya-shi (JP)

(73) Assignee: MITSUBISHI PLASTICS, INC.,, Tokyo (JP)

(21) Appl. No.: 14/006,261

(22) PCT Filed: Oct. 22, 2012
(86) PCT No.: PCT/JP2012/077221

§ 371 Date: Sep. 19, 2013

(30) Foreign Application Priority Data
Dec. 2, 2011 (JP) 2011-264764
Dec. 2, 2011 (JP) 2011-264765

(51) Int. Cl. B29D 7/01

(52) U.S. Cl. CPC B29D 7/01
USPC 427/535; 427/177; 427/553

(57) ABSTRACT

[Problem]

To provide a process for manufacturing a laminated porous film in which wrinkling is suppressed and a covering layer is laminated on at least one surface of a polyolefin-based resin porous film.

[Solution]

A process for manufacturing a laminated porous film comprising layering a covering layer on at least one surface of a polyolefin-based resin porous film, wherein film tension (Ta) in a drying step is controlled at 40 N/m or less.

### TECHNICAL FIELD

The present invention relates to a process for manufacturing a laminated porous film using a polyolefin-based resin porous film, and a separator for a battery and the battery which uses the laminated porous film. The laminated porous film manufactured in the present invention can be utilized as packaging, sanitation, animal husbandry, agriculture, construction, medical treatment, separation membranes, light diffusion plates, and battery separators. The laminated porous film can be suitably utilized particularly as a separator for nonaqueous electrolyte battery.

### BACKGROUND ART

High-molecular porous bodies having numerous fine communicative pores are utilized in various fields such as separation membranes used in the manufacturing of ultra-pure water, the purification of chemical solutions, water treatment, and the like; waterproof moisture-permeable films used in clothing, sanitation materials, and the like; and battery separators used in batterys and the like.

In particular, secondary batteries are widely used as power sources for portable devices such as OA, FA, household devices, or communication devices. Of these examples, there has been an increase of portable devices that use lithium ion secondary batteries because a volume efficiency is favorable when installed in a device and allows the devices to be compact and lightweight. Research and development for large secondary batteries has progressed in many fields associated with energy and environmental problems, such as road leveling, UPS, and electric automobiles, and the applications of lithium ion secondary batteries, which are a type of nonaqueous electrolyte secondary battery, are expanding due to their superiority in terms of having large capacity, high output, high voltage, and long-term preservation properties.

The voltage at which a lithium ion secondary battery is used is normally set with an upper limit of 4.1 V to 4.2 V. At such a high voltage, the aqueous solution causes electric decomposition and therefore cannot be used as an electrolyte solution. Therefore, a nonaqueous electrolyte solution is used, which uses an organic solvent as an electrolyte solution that can withstand even high voltages. A high-permittivity organic solvent capable of containing more lithium ions is used as the solvent for the nonaqueous electrolyte solution, and an organic ester carbonate compound such as propylene carbonate or ethylene carbonate is primarily used as the high-permittivity organic solvent. A highly reactive electrolyte such as lithium hexafluorophosphate is dissolved in the solvent and used as a supporting electrolyte for a lithium ion source in the solvent.

In a lithium ion secondary battery, a separator is interposed between a positive electrode and a negative electrode for the purpose of preventing internal short circuiting. Because of its role, the separator must be naturally insulating. To impart air permeability to allow the passage of lithium ions and a function for diffusing and maintaining the electrolyte solution, the separator must also have a fine porous structure. A porous film is used as the separator in order to satisfy these requirements.

With the increased capacity of recent batteries, the safety of the batteris has become a more important issue. A characteristic that contributes to the safety of a battery separator is the shutdown characteristic (hereinafter referred to as the “SD characteristic.” The SD characteristic is a function whereby the fine pores are closed at high temperatures of approximately 100 to 150° C., ion conduction is blocked as a result, and subsequent internal battery temperature increases can therefore be prevented. At this time, the lowest temperature at which the fine pores of the laminated porous film are closed is referred to as the shutdown temperature (hereinafter referred to as the “SD temperature”). When the film is used as a separator for battery, the film must have this SD characteristic.

However, as lithium ion secondary batteries have recently come to have higher energy densities and be more highly powered, there is a risk that the normal shutdown function will not function sufficiently, the internal battery temperature will exceed the approximately 150° C. melting point of polyethylene used as a raw material of conventional separators, the internal battery temperature increase even further, and the separator will rupture. In view of this, there is demand for a separator having both a current SD characteristic and heat resistance in order to ensure safety.

In view of these demands, there have been proposed: a separator in which a porous film of an aqueous solution polymer and a porous film of polyolefin are laminated (Patent Reference 1); a porous film in which a covering layer containing an inorganic filler and a resin binder are formed on at least one surface of a polyolefin resin porous film (Patent Reference 2); a polyolefin resin membrane comprising a porous layer composed of an inorganic filler and a polyvinyl alcohol (Patent Reference 3); and a laminated porous film in which a heat-resistant layer containing an inorganic filler and a resin binder is layered on at least one surface of a polyolefin resin porous film (Patent Reference 4), and the like.

### PRIOR ART REFERENCES

### Patent References

Patent Reference 1: Japanese Patent Application Laid-open No. 2004-227972
Patent Reference 2: Japanese Patent Application Laid-open No. 2007-280911
Patent Reference 3: Japanese Patent Application Laid-open No. 2008-186721
Patent Reference 4: WO 2011/062285

### SUMMARY OF THE INVENTION

### Problems to be Solved by the Invention

When a covering layer is formed on the porous film, normally a surface treatment such as corona treatment is performed on the surface on the side where the covering layer is provided in order to ensure adhesiveness between the covering layer and the polyolefin porous film. However, due to a polyolefin-based resin porous film for a battery separator having the characteristics of being porous and extremely thin, the film has problems in that wrinkling occurs readily in the film during the surface treatment such as corona treatment and/or after the surface treatment, and the surface-treated porous film cannot be coated cleanly. Also caused by the characteristics of being porous and extremely thin is the problem that wrinkles easily get into the porous film also during the step of providing the polyolefin porous film with a covering layer by coating or the like. Particularly, when wrinkling occurs in the porous film before a coating solution is coated, uniform coating is not possible, and as a result, the primary performance features of the separator, such as the heat resistance and air permeability, are not uniform. When wrinkling occurs in the winding step after a uniform coating application, a large amount of pressure acts on the wrinkled portion in the wound finished product, performance of the product as a separator is similarly not uniform, and there is also an adverse effect on workability when a positive electrode, negative electrode, and the like are combined to form a battery, which is undesirable.

There are also cases of wrinkling occurring and slackening of the film during the surface treatment stage, and in such cases, the corona treatment or other treatment itself cannot be performed stably, and there are portions that are not surface-treated. When there are such untreated portions, uncoated portions are formed when the covering layer is coated, for example, and when a laminated porous film having uncoated portions is used in a battery separator, it is extremely dangerous because short circuiting occurs.

In view of this, a purpose of the present invention is to provide a process for manufacturing a laminated porous film comprising layering a covering layer on at least one surface of a polyolefin-based resin porous film wherein wrinkling of the laminated porous film is suppressed.

### Means for Solving the Problems

As a result of ascertaining from various aspects the cause of wrinkling in a laminated porous film and the resolving methods thereof in a process of forming a covering layer on a polyolefin-based resin porous film by coating or the like, the inventors have discovered that wrinkling can be suppressed by controlling film tension in a drying step and a winding step within specified ranges, thus completing the present invention.

In cases in which wrinkling, flaring, slackening, and the like occur in a common thermoplastic resin film when a surface treatment such as corona treatment is performed on the surface of the side provided with the covering layer, normally these problems are resolved by passing the film over a heating roller. Therefore, as a result of research in the preventing of wrinkles by passing a porous film over a heating roll after the surface treatment, the inventors have encountered the problem of wrinkling occurring easily conversely when the film is heated. As a result of earnest research relating to these problems, the inventors and others have discovered that wrinkling is suppressed contrary to expectations when the film temperature is not raised during surface treatment, and by laminating a covering layer on the treated surface of a polyolefin-based resin porous film that has been surface-treated in this manner, wrinkling is further suppressed in the process of forming the covering layer.

Specifically, the present invention provides:

(1) a process for manufacturing a laminated porous film comprising layering a covering layer on at least one surface of a polyolefin-based resin porous film, wherein film tension (Ta) in a drying step is controlled at 40 N/m or less;

(2) a process for manufacturing a laminated porous film comprising layering a covering layer on at least one surface of a polyolefin-based resin porous film, wherein film tension (Tb) in a winding step is controlled at 40 N/m or less;

(3) a process for manufacturing a laminated porous film comprising layering a covering layer on at least one surface of a polyolefin-based resin porous film, wherein film tension (Ta) in a drying step and film tension (Tb) in a winding step satisfy the following relational expressions;

Ta≦40 N/m

Tb≦40 N/m

|Ta—Tb|<10 N/m

(4) the process for manufacturing a laminated porous film according to any one of (1) to (3), wherein the covering layer contains a filler and a resin binder;

(5) the process for manufacturing a laminated porous film according to any one of (1) to (4), wherein the covering layer is layered by coating;

(6) the process for manufacturing a laminated porous film according to any one of (1) to (5), wherein after at least one surface of the polyolefin-based resin porous film has been treated, a covering layer is layered on the treated surface;

(7) the process for manufacturing a laminated porous film according to Claim (6), wherein in the surface treatment step, the temperature of the film is controlled so as to be 50° C. or less;

(8) the process for manufacturing a laminated porous film according to (7), wherein the temperature is controlled by cooling a support roll in the surface treatment step;

(9) the process for manufacturing a laminated porous film according to (8), wherein the temperature of the support roll is controlled at 50° C. or less;

(10) the process for manufacturing a laminated porous film according to (7), wherein the wrap angle of the support roll in the surface treatment step is controlled at 120 degrees or less;

(11) the process for manufacturing a laminated porous film according to (7), wherein the support roll in the surface treatment step is a metal roll;

(12) the process for manufacturing a laminated porous film according to any one of (7) to (11), wherein the surface treatment is selected from corona treatment, plasma treatment, plasma treatment under atmospheric pressure, flame plasma treatment (flame treatment), or UV treatment;

(13) a laminated porous film obtained by the manufacturing process according to any one of (1) to (12);

(14) a separator for nonaqueous electrolyte battery which uses the laminated porous film according to (13); and

(15) a nonaqueous electrolyte battery which uses the separator for nonaqueous electrolyte battery according to (14).

### Advantages of the Invention

In the present invention, in a process for manufacturing a laminated porous film comprising layering a covering layer on at least one surface of a polyolefin-based resin porous film, wrinkling can be eliminated and continuous stable coating can be achieved by controlling film tension in a drying step and a winding step to a specified range.

### BRIEF DESCRIPTION OF THE DRAWINGS

FIG. 1 is a schematic flow sheet of an example of a coating system used in the manufacturing process of the present invention;

FIG. 2 is a schematic drawing of an example of a corona treatment system that can be used in the present invention;

FIG. 3 is an explanatory drawing of the wrap angle of the support roller; and

FIG. 4 is a partially fractured perspective view of a battery accommodating the laminated porous film of the present invention.

### BEST MODE FOR CARRYING OUT THE INVENTION

Embodiments of the process for manufacturing a laminated porous film of the present invention are described in detail below.

In the present invention, the term “main component,” unless particularly stated otherwise, incorporates meanings that allow for the inclusion of other components within a scope that does not impinge on the function of the main component, and while the content percentage of the main component is not particularly specified, the term “main component” incorporates meanings including 50 mass % or more of a composition, preferably 70 mass % or more, and more preferably 90 mass % or more (including 100%).

When the term “X to Y” (X and Y are arbitrary numerals) is used, unless defined otherwise, the term incorporates the meaning “X or greater and Y or less,” as well as the meanings “preferably greater than X” and “preferably less than Y.”

(Polyolefin-Based Resin Porous Film)

The polyolefin-based resin used in the polyolefin-based resin porous film can be a homopolymer or a copolymer containing polymerized ethylene, propylene, 1-butene, 4-methyl-1-pentene, 1-hexane, and the like. Preferred of these examples are polypropylene-based resins and polyethylene-based resins.

(Polypropylene-Based Resin)

The polypropylene-based resin can be, for example, homopropylene (a propylene homopolymer), or a random copolymer or block copolymer between propylene and an α-olefin such as 1-butene, 1-pentene, 1-hexene, 1-heptene, 1-octene, 1-nonene, or 1-decene. Of these examples, homopolypropylene is more preferably used from the standpoint of maintaining mechanical strength, heat resistance, and other properties of the laminated porous film.

The polypropylene-based resin preferably has an isotactic pentad fraction (mmmm %), which expresses stereoregularity, of 80 to 99%. 83 to 98% is more preferred, and 85 to 97% is even more preferred. When the isotactic pentad fraction is too low, there is a risk that the mechanical strength of the film will decrease. The upper limit of the isotactic pentad fraction is defined by the upper limit that has been industrially obtained at the present time, but at some point in the future, there will be no such limit when resins of higher regularity have been developed at an industrial level.

The term “isotactic pentad fraction” (mmmm %) refers to a stereoscopic structure, or a percentage thereof, in which five methyl groups as side chains are all positioned along the same direction relative to a main chain of carbon-carbon bonds configured from any five arbitrary continuous propylene units. A. Zambelli et al. (Macromolecules 8,687, (1975)) was referenced to ascribe the signals of methyl group areas.

The polypropylene-based resin preferably has a ratio Mw/Mn, which is a parameter expressing molecular weight distribution, of 2.0 to 10.0. 2.0 to 8.0 is more preferred, and 2.0 to 6.0 is even more preferred. A smaller ratio Mw/Mn would mean a narrower molecular weight distribution, but if the ratio Mw/Mn is 2.0 or greater, problems such as extrusion molding becoming difficult do not occur, and industrial production is made easier. If the ratio Mw/Mn is 10.0 or less, there are few low molecular weight components, and the mechanical strength of the laminated porous film is not compromised. The ratio Mw/Mn is obtained by GPC (gel permeation chromatography).

The melt flow rate (MFR) of the polypropylene-based resin is not particularly limited, but usually the MFR is preferably 0.5 to 15 g/10 min, and more preferably 1.0 to 10 g/10 min. When the MFR is 0.5 g/10 min or greater, the resin has a high melt viscosity during molding, and sufficient productivity can be ensured. When the MFR is 15 g/10 min or less, the mechanical strength of the resulting laminated porous film can be sufficiently maintained. The MFR is measured according to JIS K7210, at a temperature of 230° C. and under a load of 2.16 kg.

The method for manufacturing the polypropylene-based resin is not particularly limited, but can be a conventional polymerization method using a conventional polymerizing catalyst, e.g., a polymerization method or the like using a multisite catalyst typified by a Ziegler-Natta catalyst, or a single-site catalyst typified by a metallocene catalyst.

The polypropylene-based resin can be a commercially available product such as the products “Novatec PP” and “WINTEC” (made by Japan Polypropylene Corporation); “Versify,” “Notio,” and “Tafiner XR” (made by Mitsui Chemicals, Inc.); “Zealous” and “Thermorun” (made by Mitsubishi Chemicals, Ltd.); “Sumitomo Noblen” and “Tafuseren” (made by Sumitomo Chemical Co., Ltd.); “Prime Polypro” and “Prime TPO” (made by Prime Polymer Co., Ltd.); “Adflex,” “Adsyl,” and “HMS-PP (PF814)” (made by SunAllomer Ltd.); and “Inspire” (Dow Chemical).

The polyolefin-based resin porous film used in the present invention preferably has β activity.

To determine the presence or absence of “β activity” in the polyolefin-based resin porous film of the present invention, the laminated porous film is raised in temperature from 25° C. to 240° C. at a heating rate of 10° C./min as measured by a differential scanning calorimeter and kept thereat for one minute, then the laminated porous film is lowered in temperature from 240° C. to 25° C. at a cooling rate of 10° C./min and kept thereat for one minute, and the film is then again raised in temperature from 25° C. to 240° C. at a heating rate of 10° C./min, at which point the film is determined to have β activity when the crystal melting peak temperature (Tmβ) derived from the β crystals of the polypropylene-based resin is detected.

The β activity level of the porous film is calculated by the following formula, using the detected crystal heat of fusion (ΔHmα) derived from the α crystals and crystal heat of fusion (ΔHmβ) derived from the β crystals of the polypropylene-based resin.

βactivity level (%)=[ΔHmβ/(ΔHmβ+ΔHmα]×100

When the polypropylene-based resin is homopolypropylene, for example, the β activity can be calculated from the crystal heat of fusion (ΔHmβ) derived from the β crystals primarily detected in a range of 145° C. or greater to less than 160° C., and the crystal heat of fusion (ΔHmα) derived from the α crystals primarily detected at 160° C. or greater to 170° C. or less. When the resin is a random polypropylene containing 1 to 4 mol % copolymerized ethylene, the β activity can be calculated from the crystal heat of fusion (ΔHmα) derived from the β crystals primarily detected in a range of 120° C. or greater to less than 140° C., and the crystal heat of fusion (ΔHmα) derived from the α crystals primarily detected at 140° C. or greater to 165° C. or less.

The β activity level of the polyolefin-based resin porous film is preferably 20% or greater, and more preferably 40% or greater, or 60% or greater. If the laminated porous film has a β activity level of 20% or greater, a separator for lithium ion battery can be obtained in which many tiny and uniform pores are formed by stretching, mechanical strength is high as a result, and air permeability is excellent.

The upper limit of the β activity level is not particularly limited, but because the effects previously described are achieved more effectively at higher β activity levels, the nearer the upper limit is to 100%, the better.

The presence or absence of β activity can be determined from a diffraction profile obtained by wide-angle X-ray diffraction measurement of a laminated porous film that has undergone a specific heat treatment.

Specifically, wide-angle X-ray diffraction measurement is performed on a laminated porous film that has undergone a heat treatment at 170° C. to 190° C., which exceeds the melting point of the polypropylene-based resin, and has then been slowly cooled to generate and grow β crystals, and the film is determined to have β activity when the diffraction peak derived from the (300) surfaces of the β crystals of the polypropylene-based resin is detected in a range of 2θ=16.0° to 16.5°.

Details pertaining to the 0 crystal structure of the polypropylene-based resin and the wide-angle X-ray diffraction can be found by referring to Macromol. Chem. 187, 643-652 (1986), Prog. Polym. Sci. Vol. 16, 361-404 (1991), Macromol. Symp. 89, 499-511 (1995), Macromol. Chem. 75, 134 (1964), and reference documents cited in these documents. A detailed method of evaluating β activity using wide-angle X-ray diffraction is described in the Examples below.

The β activity can be measured even when the polypropylene-based resin porous film has a single-layer structure, and also in any case in which the film is laminated with other porous layers.

Even in cases of laminating a layer other than one composed of a polypropylene-based resin, such as a layer containing a polypropylene-based resin, both layers preferably have β activity.

The method of obtaining the previously described β activity can be a method of adding polypropylene that has been treated to produce peroxide radicals as disclosed in Japanese Patent Publication No. 3739481, or a method of adding a 0 crystal nucleating agent to the composition, for example.

(β Crystal Nucleating Agent)

Possible examples of the β crystal nucleating agent used in the present invention are given below, but the β crystal nucleating agent is not particularly limited as long as it promotes the production and growth of β crystals in the polypropylene-based resin, two or more of the following examples may be mixed and used together.

The β crystal nucleating agent can be, for example, an amide compound; a tetraoxaspiro compound; a quinacridone, an iron oxide of nanoscale size; an alkali earth metal salt or an alkali of carboxylic acid typified by 1,2-hydroxy potassium stearate, magnesium benzoate magnesium succinate, magnesium phthalate, or the like; an aromatic sulfonic acid compound typified by sodium benzene sulfonate, sodium naphthalene sulfonate, or the like; a diester or triester of dibasic or tribasic carboxylic acid; a phthalocyanine-based pigment typified by phthalocyanine blue or the like; a binary compound composed of a component A, which is an organic dibasic acid, and a component B, which is an oxide, a hydroxide, or a salt of a group IIA metal of the periodic table; or a composition composed of a cyclic phosphorous compound and a magnesium compound. Specific types of other nucleating agents are disclosed in Japanese Patent Application Laid-open No. 2003-306585, Japanese Patent Application Laid-open No. 06-289566, and Japanese Patent Application Laid-open No. 09-194650.

A possible example of a commercial β crystal nucleating agent is the β crystal nucleating agent “NJ Star NU-100” made by New Japan Chemical Co., Ltd., and possible specific examples of the polypropylene-based resin to which the β crystal nucleating agent is added include the polypropylene “Bepol B-022SP” made by Aristech, the polypropylene “Beta (β)-PP BE60-7032” made by Borealis, the polypropylene “BNX BETA PP-LN” made by Mayzo, and the like.

The percentage of the β crystal nucleating agent added to the polypropylene-based resin must be suitably adjusted by factors such as the type of β crystal nucleating agent and the composition of the polypropylene-based resin, but the percentage is preferably 0.0001 to 5.0 parts by mass of the g crystal nucleating agent per 100 parts by mass of the polypropylene-based resin. 0.001 to 3.0 parts by mass is more preferred, and 0.01 to 1.0 parts by mass is even more preferred. If the percentage is 0.0001 parts by mass or greater, β crystals of the polypropylene-based resin can be sufficiently produced and grown during manufacturing, sufficient β activity can be ensured when the resin is used in a separator, and the desired air permeability is obtained. The percentage is also preferably 5.0 parts by mass or less because it is economically beneficial and there is no bleeding of the β crystal nucleating agent into the surface of the laminated porous film.

Even in cases where a layer containing the polypropylene-based resin, for example, other than the layer composed of the polypropylene-based resin is layered, the added amount of the β crystal nucleating agent in both layers may be either the same or different. The porous structure of the layers can be suitably adjusted by varying the added amount of the β crystal nucleating agent.

(Other Components)

In addition to the components previously described, an additive commonly blended into resin compositions can be suitably added to the polypropylene-based resin within a range that does not significantly inhibit the effects of the present invention. The additive can be a recycled resin produced from the trimming loss at the edges or the like; inorganic particles of silica, talc, kaolin, calcium carbonate, or the like; a pigment such as titanium oxide or carbon black; or an additive such as a flame retardant, a weather-resistant stabilizer, a heat-resistant stabilizer, an antistatic agent, a surfactant, a melt viscosity enhancer, a cross-linking agent, a lubricant, a nucleating agent, a plasticizer, an age resister, an antioxidant, a light stabilizer, an ultraviolet absorbent, a neutralizer, an anticlouding agent, an antiblocking agent, a slipping agent, or a coloring agent; which are added for the purpose of improving or adjusting moldability, productivity, and various properties of the laminated porous film.

(Polyethylene-Based Resin)

In the present embodiment, a polyethylene-based resin porous film is suitably used as a porous film that is layered with the porous film composed of the polypropylene-based resin.

Possible specific examples of the polyethylene-based resin include not only homopolymer polyethylenes such as ultralow-density polyethylene, low-density polyethylene, high-density polyethylene, linear low-density polyethylene, or ultrahigh molecular weight polyethylene characterized by molecular weight, but also an ethylene-propylene copolymer or a copolymer polyethylene of a polyethylene-based resin and another polyolefin-based resin. Preferred among these examples is a homopolymer polyethylene or a copolymer polyethylene having an α-olefin comonomer content of 2 mol % or less, and a homopolymer polyethylene is more preferable. The type of α-olefin comonomer is not particularly limited.

The density of the polyethylene-based resin is preferably 0.910 to 0.970 g/cm³, more preferably 0.930 to 0.970 g/cm³, and even more preferably 0.940 to 0.970 g/cm³. The density is preferably 0.910 g/cm³ or greater because the resin will have a reasonable SD characteristic. The density is also preferably 0.970 g/cm³ or less because not only will the resin have reasonable a SD characteristic, but stretchability will also be maintained. The density can be measured using a density gradient tube method in accordance with JIS K7112.

The melt flow rate (MFR) of the polyethylene-based resin is not particularly limited, but normally the MFR is preferably 0.03 to 30 g/10 min, and more preferably 0.3 to 10 g/10 min. The MFR is preferably 0.03 g/10 min or greater because the melt viscosity of the resin during molding is sufficiently low and productivity is therefore excellent. The MFR is also preferably 30 g/10 min or less because sufficient mechanical strength can be achieved.

The MFR is measured at a temperature of 190° C. and under a load of 2.16 kg, according to JIS K7210.

The polymerization catalyst of the polyethylene-based resin is not particularly limited, but may be a Ziegler catalyst, a Phillips catalyst, a Kaminsky catalyst, or the like. Possible examples of the method for polymerizing the polyethylene-based resin include single-stage polymerization, two-stage polymerization, a greater multi-stage polymerization, or the like, and a polyethylene-based resin of any of these methods can be used.

(Porosification-Promoting Compound)

A porosification-promoting compound for promoting porosification is preferably added to the polyethylene-based resin. A porous structure can be obtained more efficiently and the pore shape and pore diameter are more easily controlled by adding the porosification-promoting compound.

The porosification-promoting compound is not limited, but to give specific examples, the compound preferably includes at least one porosification-promoting compound selected from a modified polyolefin resin, an alicyclic saturated hydrocarbon resin or a derivative thereof, an ethylene-based copolymer, or a wax. More preferred among these examples are an alicyclic saturated hydrocarbon resin or a derivative thereof, an ethylene-based copolymer, or a wax for their greater effect on porosification, and wax is even more preferred in terms of moldability.

Possible examples of the alicyclic saturated hydrocarbon resin and the modification thereof include a petroleum resin, a rosin resin, a terpene resin, a coumarone resin, an indene resin, a coumarone-indene resin, derivatives thereof, and the like.

The term “petroleum resin” in the present invention refers to an aliphatic, aromatic, or copolymerized petroleum resin obtained by simple polymerization or copolymerization of one or at least two compounds contained within a C8 or higher aromatic compound having C4 to C10 aliphatic olefins or diolefins and olefin unsaturated bonds, the aromatic compound being obtained from a side product of naphtha thermal decomposition or the like.

The petroleum resin can be an aliphatic petroleum resin having a C5 fraction as a main ingredient, an aromatic petroleum resin having a C9 fraction as a main ingredient, or a copolymerized petroleum resin or an alicyclic petroleum resin thereof, for example. Possible examples of the terpene resin include a terpene resin from β-pinene or a terpene-phenol resin; and possible examples of the rosin resin include rosin resins such as rubber rosin or wood rosin, esterified rosin resins modified with glycerine or pentaerythritol; or the like. Compatibility is comparatively favorable when an alicyclic saturated hydrocarbon resin and a modification thereof are mixed into a polyethylene-based resin, but a petroleum resin is more preferred in terms of color tone and thermal stability, and it is even more preferable to use a hydrogenated petroleum resin.

A hydrogenated petroleum resin is obtained by hydrogenating a petroleum resin by a common method. Possible examples include a hydrogenated aliphatic petroleum resin, a hydrogenated aromatic petroleum resin, a hydrogenated copolymerized petroleum resin, a hydrogenated alicyclic petroleum resin, and a hydrogenated terpene resin. Particularly preferred among these hydrogenated petroleum resins is a hydrogenated alicyclic petroleum resin which has been hydrogenated by copolymerizing a cyclopentadiene compound and an aromatic vinyl, compound. “Arkon” (made by Arakawa Chemical Industries, Ltd.) is one example of a commercially available hydrogenated petroleum resin.

The ethylene-based copolymer in the present invention is a compound obtained by copolymerizing ethylene and one or more substances selected from vinyl acetate, unsaturated carboxylic acid, unsaturated carboxylic acid anhydride, carboxylic ester, or the like.

The ethylene-based copolymer preferably has an ethylene monomer unit content of 50 mass % or more, more preferably 60 mass % or more, and even more preferably 65 mass % or more. As an upper limit, the ethylene monomer unit content is preferably 95 mass % or less, more preferably 90 mass % or less, and even more preferably 85 mass % or less. If the ethylene monomer unit content is within this predetermined range, a porous structure can be formed more efficiently.

The ethylene-based copolymer preferably has a MFR (JIS K7210, temperature: 190° C., load: 2.16 kg) of 0.1 g/10 min or more and 10 g/10 min or less. The MFR is preferably 0.1 g/10 min or more because satisfactory extrudability can be maintained, and the MFR is preferably 10 g/10 min or less because the film strength is not likely to decrease.

For the ethylene-based copolymer, it is possible to commercially obtain: “EVAFLEX” (made by Mitsui-DuPont Polychemical Co., Ltd.) or “Novatec EVA” (made by Japan Polyethylene Co., Ltd.) as an ethylene-vinyl acetate copolymer; “NUC copolymer” (made by Nippon Unicar Co., Ltd.),” Evaflex EAA″ (made by Mitsui-DuPont Polychemical Co., Ltd.), or “REXPEARL EAA” (made by Japan Ethylene Co., Ltd.), as an ethylene-acrylic acid copolymer; “ELVALOY” (made by DuPont-Mitsui Polychemical Co., Ltd.) or “REXPEARL EMA” (made by Japan Ethylene Co., Ltd.) as an ethylene-(meth)acrylic acid copolymer; “REXPEARL EEA” (made by Japan Ethylene Co., Ltd.) as an ethylene-acrylic acid ethyl copolymer; “Acryft” (made by Sumitomo Chemical Co., Ltd.) as an ethylene-methyl (meth)acrylic acid copolymer; “Bondine” (made by Sumitomo Chemical Co., Ltd.) as an ethylene-vinyl acetate-maleic anhydride ternary copolymer; an ethylene-glycidyl methacrylate copolymer; an ethylene-vinyl acetate-glycidyl methacrylate ternary copolymer; “Bondfast” (made by Sumitomo Chemical Co., Ltd.) as an ethylene-ethyl acrylate-glycidyl methacrylate ternary copolymer; or the like.

The wax in the present invention is an organic compound that satisfies the following qualities (a) and (b).

(a) The melting point is 40° C. to 200° C.

(b) The melt viscosity at a temperature 10° C. higher than the melting point is 50 Pa·s or less.

The wax includes a polar or nonpolar wax, a polypropylene wax, a polyethylene wax, and a wax modifier. Specifically, the wax can be a polar wax, a nonpolar wax, a Fischer-Tropsch wax, an oxidized Fischer-Tropsch wax, a hydroxystearamide wax, a functionalized wax, a polypropylene wax, a polyethylene wax, a wax modifier, an amorphous wax, carnauba wax, castor oil wax, a microcrystalline wax, beeswax, carnauba wax, castor wax, vegetable wax, candelilla wax, Japan wax, ouricury wax, Douglas fir bark wax, rice bran wax, jojoba wax, bayberry wax, montan wax, ozocerite wax, ceresin wax, petroleum wax, paraffin wax, chemically modified hydrocarbon wax, substituted amide wax, and combinations and derivatives thereof. For their ability to efficiently form a porous structure, preferred among these are paraffin wax, a polyethylene wax, and a microcrystalline wax, and more preferred from the standpoint of the SD characteristic is a microcrystalline wax which can further micronize pore diameter. “FT-115” (made by Nippon Seiro Co., Ltd.) is an example of a commercially available polyethylene wax, and “Hi-Mic” (made by Nippon Seiro Co., Ltd.) is an example of a microcrystalline wax.

When the surfactant between the polyethylene-based resin and the porosification-promoting compound is separated to form micropores, the blended amount of the porosification-promoting compound is preferably 1 part by mass or more as a lower limit per 100 parts by mass of the further included polyethylene-based resin, more preferably 5 parts by mass or more, and even more preferably 10 parts by mass or more. As an upper limit, 50 parts by mass or less is preferred, 40 parts by mass or less is more preferred, and 30 parts by mass or less is even more preferred. The effects manifested by the intended satisfactory porous structure are sufficiently achieved by blending the porosification-promoting compound in an amount of 1 part by mass or more per 100 parts by mass of the polyethylene-based resin. A more stable moldability can be ensured by blending the porosification-promoting compound in an amount of 50 parts by mass or less.

In addition to a polyethylene-based resin or a porosification-promoting compound, a thermoplastic resin may be used as necessary within a range that does not compromise the thermal characteristics, i.e. the porosification of the porous film. Possible examples of another thermoplastic resin that can be mixed with the polyethylene-based resin previously described include: a styrene-based resin such as polystyrene, an AS resin, or an ABS resin; polyvinyl chloride, a fluorine resin, an ester-based resin such as polyethylene terephthalate, polybutylene terephthalate, polycarbonate, or polyarylate; an ether-based resin such as polyacetal, polyphenylene ether, polysulfone, polyether sulfone, polyether ether ketone, or polyphenylene sulfide; a polyamide resin such as 6 nylon, 6-6 nylon, 6-12 nylon; or the like.

A component referred to as a rubber component, such as a thermoplastic elastomer, may be added as necessary. Possible examples of the thermoplastic elastomer include styrene-butadiene, polyamide, 1,2-polybutadiene, polyvinyl chloride, ionomers, and the like.

In addition to the polyethylene-based resin and the porosification-promoting compound, an additive or another component commonly blended into resin compositions may also be included. Possible examples of an additive include a recycled resin produced from the trimming loss at the edges or the like; inorganic particles of silica, talc, kaolin, calcium carbonate, or the like; a pigment such as titanium oxide or carbon black; or an additive such as a flame retardant, a weather-resistant stabilizer, a heat-resistant stabilizer, an antistatic agent, a surfactant, a melt viscosity enhancer, a cross-linking agent, a lubricant, a nucleating agent, a plasticizer, an age resister, an antioxidant, a light stabilizer, an ultraviolet absorbent, a neutralizer, an anticlouding agent, an antiblocking agent, a slipping agent, or a coloring agent; which are added for the purpose of improving or adjusting moldability, productivity, and various properties of the laminated porous film.

Of these, a nucleating agent is preferred for its effects of controlling the crystal structure of the polyethylene-based resin and making the porous structure finer during stretched pore opening. Examples of commercially available agents include “Geruoru D” (made by New Japan Chemical Co., Ltd.), “ADK STAB” (made by Asahi Electronics Co., Ltd.), “Hyperform” (made by Milliken Chemical Co., Ltd.), “IRGACLEAR D” (made by Ciba Specialty Chemicals), and the like. “Rikemaster” (made by Riken Vitamin Co., Ltd.) or the like is a specific example of a commercially obtainable polyethylene-based resin containing an added nucleating agent.

(Layer Structure of Polyolefin-Based Resin Porous Film)

In the present invention, the polyolefin-based resin porous film may be composed of a singlelayer or a plurality of layers. When the film is layered in two or more layers, the film is preferably a laminate comprising a layer containing a polypropylene-based resin and a layer containing a polyethylene-based resin.

The layer structure of the polyolefin-based resin porous film is not particularly limited as long as there is at least one layer containing a polypropylene-based resin (hereinafter referred to as the “A layer”). Another layer (hereinafter referred to as the “B layer”) can also be layered within a range that does not hinder the functions of the polyolefin-based resin porous film. An example is a structure consisting of a lamination of a strength-preserving layer, a heat-resistant layer (a high-melting temperature resin layer), a shutdown layer (a low-melting temperature resin layer), and the like. When the film is used as a lithium ion battery separator, for example, it is preferable to layer a low-melting point resin layer in which the pores are closed in a high-temperature atmosphere and battery safety is ensured, such as is disclosed in Japanese Patent Application Laid-open No. 04-181651.

Possible specific examples include a two-layer structure consisting of a layered A layer/B layer, a three-layer structure consisting of a layered A layer/B layer/A layer or a B layer/A layer/B layer, or the like. It is also possible to combine these layers with a layer having another function to form three layers of three different types. In this case, the order of lamination with the layer having the other function is not particularly an issue. The number of layers may also be increased as necessary to four, five, six, or seven.

The properties of the polyolefin-based resin porous film of the present invention can be freely adjusted by the layer structure, the layering ratio, the composition of the layers, and the manufacturing process.

(Process for Manufacturing Polyolefin-Based Resin Porous Film)

Next, the process for manufacturing of the polyolefin-based resin porous film of the present invention is described, but the present invention is not limited to only a laminated porous film manufactured by this manufacturing process.

The process for producing a non-porous membrane material is not particularly limited and conventional methods may be used, but one possible example is a method in which a thermoplastic resin composition is melted using an extruder, and the composition is extruded from a T die and cooled and solidified by a cast roll. Another method that can be applied is a method of cutting open a membrane material manufactured by a tubular method, and flattening the material.

The porosification method in the non-porous membrane material is not particularly limited, and conventional methods may be used, such as porosification by wet stretching along one or more axes and porosification by dry stretching along one or more axes. Stretching methods include methods such as roll stretching, rolling, tenter stretching, and simultaneous biaxial stretching, and these methods may be performed singly or two or more may be combined to perform uniaxial stretching or biaxial stretching. Of these, successive biaxial stretching is preferred in terms of porous structure control.

In the present invention, when a polyolefin-based resin porous film is composed of a plurality of layers laminated, the manufacturing method is generally classified into the following four methods depending on the order of porosification and lamination.

(a) A layering method comprising porosifying the layers, and then laminating the porosified layers or bonding the layers together by an adhesive or the like.

(b) A method comprising layering the layers to prepare a laminated non-porous membrane material, and then porosifying the non-porous membrane material.

(c) A porosification method comprising layering another layer of a non-porous membrane material after any one of the layers has been porosified.

(d) A method comprising obtaining a laminated porous film by fabricating a porous layer and then coating the layer with inorganic or organic particles, vapor-depositing metal particles, or the like.

In the present invention, it is preferable to use the method of (b) in terms of the simplicity of the steps and productivity, and in order to ensure adhesion between the two layers, it is particularly preferable to use a porosification method after a laminated non-porous membrane material has been prepared by coextrusion.

The details of the method for manufacturing a polyolefin-based resin porous film are described below.

First, a mixed resin composition containing a polypropylene-based resin, and if necessary a thermoplastic resin and an additive, is prepared. Raw materials such as a polypropylene-based resin, a 0 crystal nucleating agent, and other additives as desired, for example, are either mixed using preferably a Henschel mixer, a super mixer, a tumbler mixer, or the like, or are all put into a bag and mixed by hand blending, after which the materials are melt-kneaded in a single-screw or twin-screw extruder, a kneader, or the like, but preferably a twin-screw extruder, and the kneaded materials are then cut into pellets.

The pellets are deposited in an extruder and extruded from a T die extrusion mouthpiece to mold a membrane material. The type of T die is not particularly limited. When the laminated porous film of the current embodiment of the present invention has a layered structure of two types of three layers, for example, the T die may be a two-type three-layer multi-manifold type of die, or a two-type three-layer feed block type of die.

The gap of the T die used herein is ultimately determined from the required film thickness, the stretching conditions, the draft ratio, and various other conditions, but is commonly about 0.1 to 3.0 mm, and preferably 0.5 to 1.0 mm. The gap is preferably 0.1 mm or greater in terms of the production rate, and is preferably 3.0 mm or less in terms of production stability because the draft ratio decreases.

During extrusion molding, the extrusion working temperature is suitably adjusted according to the fluid characteristics, moldability, and other characteristics of the resin composition, but generally the temperature is preferably 180 to 350° C., more preferably 200 to 330° C., and even more preferably 220 to 300° C. The extrusion working temperature is preferably 180° C. or greater because the melted resin will have a sufficiently low viscosity, excellent moldability, and improved productivity. With an extrusion working temperature of 350° C. or less, deterioration of the resin composition can be suppressed, and consequently decreases in the mechanical strength of the resulting laminated porous film can also be suppressed.

When a β crystal nucleating agent is added, the cooling/solidifying temperature of the cast roll is extremely important, and the ratio of β crystals of the polypropylene-based resin in the membrane material can be adjusted. The cooling/solidifying temperature of the cast roll is preferably 80 to 150° C., more preferably 90 to 140° C., and even more preferably 100 to 130° C. The cooling/solidifying temperature is preferably 80° C. or more because the ratio of β crystals in the membrane material can be sufficiently increased. The cooling/solidifying temperature is also preferably 150° C. or less because there are unlikely to be problems such as the extruded melted resin sticking to and wrapping around the cast roll, and a membrane material can be formed efficiently.

The β crystal ratio of the polypropylene-based resin in the membrane material before stretching is preferably adjusted to 20 to 100% by setting a cast roll in the temperature range previously described. 40 to 100% is more preferred, 50 to 100% is even more preferred, and 60 to 100% is most preferred. With a β crystal ratio of 30% or more in the membrane material before stretching, porosification is made easier by the subsequent stretching operation, and a polyolefin-based resin porous film having good air permeability can be obtained.

The β crystal ratio in the membrane material before stretching is calculated by the following formula, using the crystal heat of fusion (ΔHmα) derived from the α crystals and the crystal heat of fusion (ΔHmβ) derived from the β crystals of the polypropylene-based resin, which are detected using a differential scanning calorimeter when the temperature of the membrane material is raised from 25° C. to 240° C. at a heating rate of 10° C./min.

β crystal ratio(%)=[ΔHmβ/(ΔHmβ+ΔHmα)]×100

In the stretching step, the film may be stretched uniaxially in the longitudinal direction or the transverse direction, or the film may be stretched biaxially. When biaxial stretching is performed, the film may be stretched along both axes simultaneously, or the film may be stretched along the two axes successively. When the polyolefin-based resin porous film of the present invention is prepared, it is more preferable to use successive biaxial stretching in which the stretching conditions can be selected in the stretching steps and the porous structure is more easily controlled.

The lengthwise direction of the membrane material and the film is referred to as the “longitudinal direction,” and the direction perpendicular to the longitudinal direction is referred to as the “transverse direction.” Stretching in the lengthwise direction is referred to as “longitudinal stretching,” and stretching in the direction perpendicular to the longitudinal direction is referred to as “transverse stretching.”

When successive biaxial stretching is used, the stretching temperature must be timely varied according to factors such as the makeup of the resin composition, the crystal fusion peak temperature, and the degree of crystallization, but the stretching temperature during longitudinal stretching is preferably controlled to a range of 0 to 130° C., more preferably 10 to 120° C., and even more preferably 20 to 110° C. The longitudinal stretch ratio is preferably 2 to 10 times, more preferably 3 to 8 times, and even more preferably 4 to 7 times. Rupturing during stretching can be suppressed and suitable pore origins can be achieved by performing longitudinal stretching within these ranges.

The stretching temperature during transverse stretching is 100 to 160° C., preferably 110 to 150° C., and more preferably 120 to 140° C. The preferred transverse stretch ratio is preferably 2 to 10 times, more preferably 3 to 8 times, and even more preferably 4 to 7 times. The pore origins formed by longitudinal stretching can be suitably enlarged and a fine porous structure can be achieved by performing transverse stretching within these ranges.

The stretching rate during the stretching steps is preferably 500 to 12000%/min, more preferably 1500 to 10000%/min, and even more preferably 2500 to 8000%/min.

The porous film obtained in this manner is preferably subjected to a heat treatment for the purpose of improving dimensional stability. At this time, dimensional stability effect can be expected with a temperature of preferably 100° C. or greater, more preferably 120° C. or greater, and even more preferably 140° C. or greater. The heat treatment temperature is preferably 170° C. or less, more preferably 165° C. or less, and even more preferably 160° C. or less. The heat treatment temperature is preferably 170° C. or less because the polypropylene is not likely to be melted by the heat treatment and the porous structure can be maintained. A slackening treatment of 1 to 20% may be performed as necessary during the heat treatment step. After the heat treatment, the film is uniformly cooled and wound, thereby obtaining the porous film of the present invention.

(Process for Manufacturing Laminated Porous Film)

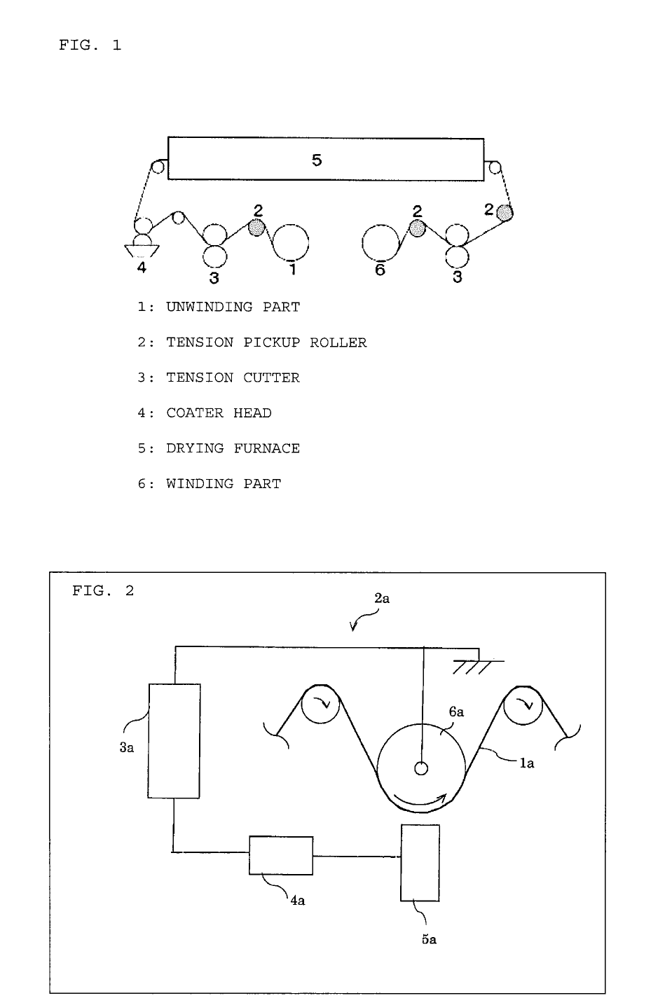

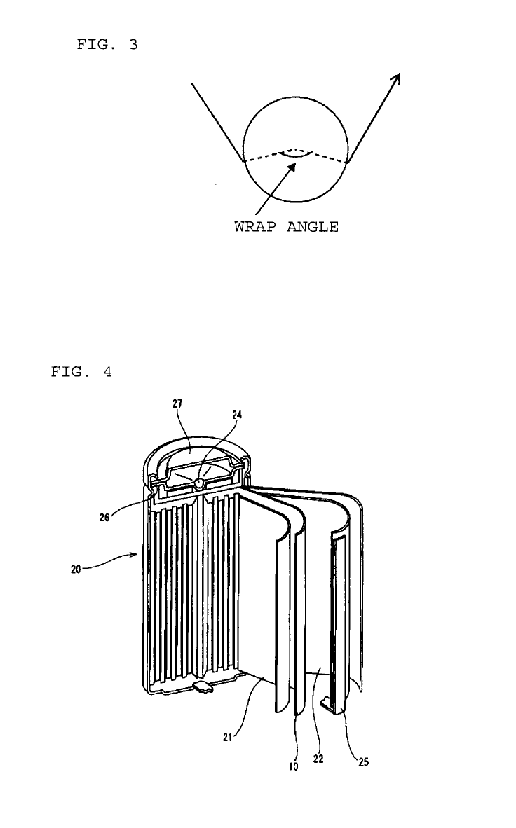

The present invention relates to a process for manufacturing a laminated porous film by layering a covering layer on at least one surface of a polyolefin-based resin porous film. In the present invention, the film tension (Ta) in the drying step and the film tension (Tb) in the winding step are preferably controlled to a specified range. In the manufacturing process of the present invention, the laminated porous film is preferably manufactured by layering a covering layer by coating on at least one surface of the polyolefin-based resin porous film. FIG. 1 shows a schematic flow sheet of an example of a coating system used in the manufacturing process of the present invention.

In the present invention, the film tension (Ta) in the drying step is preferably controlled to 40 N/m or less, and more preferably 35 N/m or less. The film tension (Ta) in the drying step is the tension when the film is being passed through the entire drying step, and measuring this tension normally involves using the value of the tension of the film in a tension pickup roll provided to the location where the film exits the drying step shown in FIG. 1. Control of the film tension (Ta) in the drying step is performed by a feedback system, using a tensile force detector connected to the tension pickup roll.

In the present invention, the drying means in the drying step is composed of a drying furnace (hot air current circulation, jetting, or the like), an infrared heater, or the like.

In the present invention, the film tension (Tb) in the winding step is preferably controlled to 40 N/m or less, more preferably 35 N/m or less, and even more preferably 30 N/m or less. The film tension (Tb) in the winding step normally involves using the value of tension in a tension pickup roll provided ahead of the winding roll shown in FIG. 1. In the present invention, control of the film tension (Tb) in the winding step is performed by a feedback system, using a tensile force detector connected to the tension pickup roll.

In a more preferred aspect of the present invention, the film tension (Ta) in the drying step and the film tension (Tb) in the winding step satisfy the relationships Ta≦40 N/m, Tb≦40 N/m, and |Ta−Tb|<10 N/m. By controlling the film tension (Ta) in the drying step and the film tension (Tb) in the winding step within such ranges, wrinkling is virtually eliminated, and continuous stable coating can be achieved.

In the present invention, after at least one surface of the polyolefin-based resin porous film has been treated, a covering layer is preferably layered on the treated surface.

The surface treatment in the present invention is a physical or chemical surface modification treatment which can improve the adhesiveness of the surface of the polyolefin-based resin porous film. Examples include corona treatment, plasma treatment, plasma treatment under atmospheric pressure, flame plasma treatment (flame treatment), UV treatment, and the like, but the treatment is not limited to these examples. In the present invention, the surface treatment can be performed using conventional conditions and equipment that can be used with a polyolefin-based resin porous film.

In the present invention, the porous film can be surface treated across the entire width, or the porous film can be surface treated in stripes (partially). When the laminated porous film is manufactured, either the untreated portions cannot be coated by coating or the like, or, if the untreated portions can be coated, they can be peeled off because they are not adhered with the porous film as a base material. Therefore, the film can be manufactured with the entire surface coated even when a stripe-coated product is required.

FIG. 2 shows a schematic of an example of a corona treatment system that can be used in the present invention. The corona treatment system 2a in this drawing has a high-frequency power source 3a, a controller 4a, and an electrode 5a. A porous film la is wound over a grounded treatment roll 6, and is disposed so as to pass very close to the electrode 5 at a constant speed. Corona discharge is generated by applying a high-frequency, high-voltage output from the high-frequency power source 3a between the electrode 5a and the treatment roll 6a. The porous film 1 is passed through this corona discharge, and the discharged energy acts on the porous film 1a.

In a preferred aspect of the present invention, when a surface treatment such as the above-described corona treatment is performed on the surface of a polyolefin-based resin porous film, wrinkling of the porous film on the support roll can be suppressed, as can alterations and damage (based on narrowing of the distance between wrinkled parts and the corona treatment electrode) in wrinkled portions, by controlling the temperature of the film. In the present invention, the phrase “when a surface treatment is performed” refers in a precise sense to the time during which the surface treatment is being received, but in actuality also includes the time immediately following the surface treatment because it is extremely difficult to measure the temperature of the treated film surface in that instant. In the present invention, the film temperature is measured by methods disclosed in the Examples described hereinafter.

In a preferred embodiment of the present invention, when a surface treatment is performed on the surface of the polyolefin-based resin porous film, it is preferable that the temperature is controlled so that the film temperature is 50° C. or less, it is more preferable that the temperature is controlled so that the film temperature is 40° C. or less, and it is particularly preferable that the temperature is controlled so that the film temperature is 30° C. or less. When the surface treatment is performed, wrinkles in the porous film during and after the surface treatment can be effectively suppressed by controlling the temperature of the porous film within this range.

In a preferred embodiment of the present invention, the means for controlling the temperature can be means for controlling the temperature of the support roll (6a in FIG. 2 in the previously described example of corona treatment) in the surface treatment step, means for enabling the material of the support roll to satisfactorily release heat, means for controlling the wrap angle of the support roll, means for adjusting the air temperature of the atmosphere, and the like.

The means for controlling the temperature of the support roll can be a heater, a circulating flow channel for supplying or discharging a heat medium (water, silicon oil, and the like are preferred), for example, and exchanging heat, or the like. The temperature of the support roll can be controlled by varying the temperature of the heat medium, the circulation rate, and the heater power supply rate. In the present invention, the porous film temperature can be controlled when the surface treatment is performed by controlling the roll temperature preferably to 50° C. or less.

In a preferred embodiment of the present invention, the porous film temperature can also be controlled when the surface treatment is performed by controlling the wrap angle of the support roll. The wrap angle of the support roll is an angle formed when the two contact points between the porous film and the support roll and the center of the support roll are connected. Commonly, the greater the wrap angle, the more stably the corona treatment or other surface treatment can be performed, but because the resistance of the porous film against the support roll during the surface treatment is reduced and sliding between the roll and film slide is improved by reducing the wrap angle, wrinkles can be prevented. In the present invention, the wrap angle of the support roll is preferably 120 degrees or less, and more preferably 90 degrees or less. When the wrap angle is too small, air gets in between the support roll and the film and there can sometimes be electrical discharge on the reverse side of the treated surface of the film, and when electrical discharge on the reverse surface is undesirable in terms of the required performance of the film, the wrap angle is preferably adjusted to range in which there are no wrinkles.

In a preferred embodiment of the present invention, a metal roll can be used as the support roll. An insulating roll such as a rubber roll is used as the support roll in normal corona treatment or the like, but there are also corona treatment systems in which the support roll is made of metal and the electrode is an insulating ceramic, and in a preferred embodiment of the present invention, the surface treatment can be performed with this type of a corona treatment system or the like. In such cases, the support roll, being made of metal, releases heat well, and the temperature of the roll can be easily controlled. This is also effective in preventing wrinkles in terms of the slipperiness of the film.

In the surface treatment step as described above, with a polyolefin-based resin porous film treated by a surface treatment method for controlling temperature so that the film temperature is 50° C. or less, a porous film that has been stably and uniformly surface-treated can be obtained because wrinkling during the surface treatment is suppressed. Therefore, further wrinkling can be suppressed in the process of forming the covering layer, by layering the covering layer on the treated surface of the polyolefin-based resin porous film that has been surface-treated in this manner.

In the present invention, the covering layer can be formed over the entire width of the porous film, or the covering layer can be formed partially, such as in the form of stripes. If the method for partially forming a covering layer is gravure coating, for example, wherein the coating head is designed so as to be capable of applying partial coatings, possible examples include a method of partially sculpting a gravure roll (only the portions where the covering layer is to be formed), a method of slightly reducing the diameter of the gravure roll of the portion where the non-coated parts are to be formed in comparison with the coated portions, and the like. If die coating is used, seams are preferably inserted in between the die lips at the positions where the non-coated parts are to be formed to suppress discharging of the coating solution. A partial covering layer can also be formed by performing the surface treatment in partial locations before coating. If there is a large difference in surface tension between the untreated portions and the coating solution, the covering layer can be formed by the energy difference alone, and after the entire surface has been coated including the untreated portions, the covering layer of the untreated portions where adhesion is low can be peeled off.

Non-coated portions can be provided to both ends of the porous film as the base material, and/or to multiple locations in the width direction.

Normally with laminated porous film, the covering layer is formed on a wide porous film and the film is afterward slit at predetermined widths, but when the covering layer is hard, there is a problem in that the slitting blade is worn easily. When the covering layer is formed in stripes as described above, the film can be slit in the untreated portions and the slitting blade can be prevented from becoming worn.

When a covering layer in the form of stripes is provided in multiple locations along the width direction of the film, the linear expansion coefficient of the film differs between portions having the covering layer and portions not having the covering layer, and wrinkling therefore readily occurs particularly in the borders having the covering layer when the laminated porous film is wound. When the method of the present invention is used, wrinkling can be effectively suppressed even in aspects in which such a striped covering layer is formed.

(Covering Layer)

In the present invention, various covering layers can be used as the covering layer, but it is particularly preferable in the present invention to use a heat-resistant layer containing a filler and a resin binder. A heat-resistant layer can be formed on the surface of the porous film by applying a coating of a filler-containing resin solution (a dispersion solution), in which a filler and a resin binder are dissolved or dispersed in a solvent, to the surface of the polyolefin-based resin porous film that has been surface-treated. The components constituting the heat-resistant layer and the manufacturing methods thereof are described below.

(Filler)

The filler that can be used in the present invention can be an inorganic filler, an organic filler, or the like, but there are no particular restrictions.

Examples of inorganic fillers include: carbonate salts such as calcium carbonate, magnesium carbonate, and barium carbonate; sulfate salts such as calcium sulfate, magnesium sulfate, and barium sulfate; chlorides such as sodium chloride, calcium chloride, and magnesium chloride; oxides such as aluminum oxide, calcium oxide, magnesium oxide, zinc oxide, titanium oxide, and silica; as well as silicate salts such as talc, clay, mica; and the like. Of these examples, barium sulfate and aluminum oxide are preferred.

Examples of organic fillers include thermosetting resins and thermoplastic resins such as ultra-high molecular weight polyethylene, polystyrene, polymethyl methacrylate, polycarbonate, polyethylene terephthalate, polybutylene terephthalate, polyphenylene sulfide, polysulfone, polyether sulfone, polyether ether ketone, polytetrafluoroethylene, polyimide, polyether imide, melamine, and benzoguanamine. Of these examples, cross-linked polystyrene or the like is particularly preferred.

The average particle diameter of the filler is preferably 0.1 μm or greater, more preferably 0.2 μm or greater, and even more preferably 0.3 μm or greater, and the upper limit is preferably 3.0 μm or less, and more preferably 1.5 μm or less. An average particle diameter of 0.1 μm or greater is preferable in terms of reducing the shrinkage ratio of the laminated porous film to make the film less susceptible to rupturing, and also in terms of achieving heat resistance. An average particle diameter of 3.0 μm or less is preferable in terms of reducing the shrinkage ratio of the laminated porous film to make the film less susceptible to rupturing. An average particle diameter of 1.5 μm or less is also preferable in terms of satisfactorily forming a porous layer having a low layer thickness, and also in terms of the dispersiveness of the inorganic filler in the porous layer.

The “average particle diameter of the inorganic filler” in the present embodiment is a value measured according to methods using SEM.

In the heat-resistant layer, the percentage of the filler (hereinbelow referred to as the “F %”) in the combined total of the filler and the resin binder is preferably 92 mass % or greater, more preferably 95 mass % or greater, and even more preferably 98 mass % or greater. An F % of 92 mass % or greater is preferable because a laminated porous film capable of communication can be produced, and excellent air permeability can be exhibited.

(Resin Binder)

Examples of resin binders that can be used in the present invention are not particularly limited as long as they can satisfactorily bond the filler and the polyolefin-based resin porous film, they are electrochemically stable, and they are stable in an organic electrolytic solution when the laminated porous film is used as a battery separator. Specific examples include an ethylene vinyl acetate copolymer (EVA, structural units derived from vinyl acetate constituting 20 to 35 mol %), an ethylene-acrylic acid copolymer such as an ethylene-ethyl acrylate copolymer, a fluororesin [polyvinylidene fluoride (PVDF), polyvinylidene-hexafluoropropylene, polyvinylidene-trichloroethylene, and the like], fluorine rubber, styrene-butadiene rubber (SBR), nitrile butadiene rubber (NBR), polybutadiene rubber (BR), polyacrylonitrile (PAN), polyacrylic acid (PAA), carboxymethyl cellulose (CMC), hydroxyethyl cellulose (HEC), polyvinyl alcohol (PVA), cyanoethyl polyvinyl alcohol, polyvinyl butyral (PVB), polyvinylpyrrolidone (PVP), poly N-vinyl acetamide, a polyether, a polyamide, a polyimide, a polyamide imide, a polyaramid, a crosslinked acrylic resin, a polyurethane, an epoxy resin, and the like. These organic binders may be used singly or in combinations of two or more. Of these examples, polyvinyl alcohol, polyvinylidene fluoride, styrene-butadiene rubber, carboxymethyl cellulose, and polyacrylic acid are preferred.

(Method for Forming Heat-Resistant Layer)

In the present invention, a heat-resistant layer can be formed on the surface of the porous film by coating the surface-treated surface of the polyolefin-based resin porous film with a filler-containing resin solution (dispersion solution) obtained by dissolving or dispersing the filler and the resin binder in a solvent (that is, applying the solution to the surface).

The solvent can be a solvent in which the filler and the resin binder can be dissolved or dispersed uniformly and stably. Possible examples of such a solvent include N-methyl pyrrolidone, N-dimethyl formamide, N, N-dimethyl acetamide, water, ethanol, toluene, hot xylene, hexane, and the like. To stabilize the inorganic filler-containing resin solution or to improve the ability of the polyolefin-based resin porous film to be coated, various additives may be added to the dispersion solution, such as a surfactant or another dispersant, a thickener, a wetting agent, an antifoaming agent, and a PH regulator containing oxygen or an alkali. These additives are preferably something that can be removed when the solvent is removed or a plasticizer is extracted, but the additives may remain in the battery (in the laminated porous film) if they are electrochemically stable in the usage range of lithium ion secondary batteries, if they do not impede the battery reaction, and if they are stable up to about 200° C.

Possible examples of the method for dissolving or dispersing the filler and the resin binder in a solvent include a ball mill, a bead mill, a planetary ball mill, a vibrating ball mill, a sand mill, a colloid mill, an attritor, a roller mill, high-speed impeller dispersion, a disperser, a homogenizer, a high speed impact mill, ultrasonic dispersion, mechanical stirring with a stirring blade or the like, etc.

The method for coating the surface of the polyolefin-based resin porous film with the dispersion solution is not particularly limited as long as the method can achieve the required layer thickness and coating surface area. Possible examples of such a coating method include methods using a gravure coater, a small-diameter gravure coater, a reverse roller coater, a transfer roller coater, a kiss coater, a dip coater, a knife coater, an air doctor coater, a blade coater, a rod coater, a squeeze coater, a cast coater, a die coater, screen printing, spray coating, and the like. The dispersion solution may be used to coat either only one surface or both surfaces of the polyolefin-based resin porous film, according to the application.

The solvent is preferably a solvent that can be removed from the coating of the dispersion solution on the polyolefin-based resin porous film. The method for removing the solvent is not particularly limited, and any method can be employed that does not have an adverse effect on the polyolefin-based resin porous film. Possible examples of the method for removing the solvent include a method of drying the polyolefin-based resin porous film at a temperature equal to or less than the melting point of the film while keeping the film held in place, a method of depressurizing and drying the film at a low temperature, a method of immersing the film in a solvent that is poor relative to the resin binder to cause the resin binder to coagulate while simultaneously extracting the solvent, and the like.

A laminated porous film comprising a heat-resistant layer layered on the surface of the polyolefin-based resin porous film of the present invention can be manufactured using a different method from the manufacturing methods described above. For example, raw material for the polyolefin-based resin porous film can be put in one extruder, raw material for the heat-resistant layer can be put in another extruder, and a porosification treatment method can be employed after the extruded results have been integrated to mold a laminated membrane material.

In the present invention, the heat-resistant layer can be formed inline after the surface treatment of the present invention has been performed on the surface of the polyolefin-based resin porous film, but it is also possible to wind up the porous film and form the heat-resistant layer offline in another step after the surface treatment.

(Shape and Properties of Laminated Porous Film)

The thickness of the laminated porous film obtained using the manufacturing method of the present invention is preferably 5 to 100 μm as previously described. A thickness of 8 to 50 μm is more preferred, and 10 to 30 μm is even more preferred. When the film is used as a battery separator, the required electrical insulation can be substantially achieved if the thickness is 5 μm or greater, and even when a large force acts on the protruding portion of the electrode, for example, the electrode is unlikely to pierce through the battery separator and short circuit, remaining highly safe. If the film thickness is 100 μm or less, the performance of the battery can be sufficiently ensured because the electrical resistance of the laminated porous film can be reduced.

From the standpoint of improving heat resistance, the heat-resistant layer preferably has a thickness of 0.5 μm or greater, more preferably 2 μm or greater, even more preferably 3 μm or greater, and 4 μm or greater is particularly preferred. From the standpoint of permeability and increasing the capacity of the battery, the upper limit is preferably 90 μm or less, more preferably 50 μm or less, even more preferably 30 μm or less, and 10 μm or less is particularly preferred.

In the laminated porous film of the present invention, the porosity is preferably 30% to 70% as previously described, and if the porosity is 30% or greater, a laminated porous film can be formed which is guaranteed to be communicable and which has excellent air permeation properties. If the porosity is 70% or less, the strength of the laminated porous film is not likely to decrease, which is preferable from the standpoint of handling.

As previously described, the laminated porous film of the present invention has an air permeability of 2000 sec/100 mL, as measured based on JIS P8117.

To endow the film with SD properties when the film is used as a separator for battery, the air permeability after heating for 5 seconds at 135° C. is 10000 sec/100 mL, the pores are quickly closed during abnormal heat generation, electric current is blocked, and problems such as battery rupturing can be avoided.

(Battery)

A nonaqueous electrolyte battery, in which the laminated porous film of the present invention is accommodated as a separator for battery, is described using FIG. 4.

Both a positive electrode plate 21 and a negative electrode plate 22 are wound into spiral shapes so as to overlap each other with a separator for battery 10 interposed between the two, and the outer sides are secured by fastening tape, forming a wound body.

The wound body consisting of the positive electrode plate 21, the separator for battery 10, and the negative electrode plate 22 integrally wound together is accommodated in a bottomed cylindrical battery case, and is welded with lead bodies 24, 25 of the positive and negative electrodes. Next, the electrolyte is poured into a battery canister, and after the electrolyte has sufficiently saturated the separator for battery 10 and the other components, a positive electrode lid 27 is sealed over the open peripheral edge of the battery canister via a gasket 26, preliminary charging and aging are performed, and a secondary battery 20 composed of a tubular nonaqueous electrolyte battery is produced.

An electrolyte solution having lithium salt as the electrolyte, which is dissolved in an organic solvent, is used as the electrolyte solution. The organic solvent is not particularly limited, but possible examples include: esters such as propylene carbonate, ethylene carbonate, butylene carbonate, γ-butyrolactone, γ-valerolactone, dimethyl carbonate, methyl propionate, or butyl acetate; nitriles such as acetonitriles; ethers such as 1,2-dimethoxyethane, 1,2-dimethoxy methane, dimethoxypropane, 1,3-dioxolane, tetrahydrofuran, 2-methyl tetrahydrofuran, or 4-methyl-1,3-dioxolane; sulfolane; and the like. These examples can be used singly or in mixtures of two or more.

Preferred among these examples is an electrolyte in which lithium hexafluorophosphate (LiPF₆) is dissolved in a percentage of 1.0 mol/L in a solvent consisting of 2 parts by mass of methyl ethyl carbonate mixed with 1 part by mass of ethylene carbonate.

For the negative electrode, an alkali metal or a compound containing an alkali metal is integrated with a current-collecting material such as a stainless steel mesh. Possible examples of the alkali metal include lithium, sodium, potassium, and the like. Possible examples of the compound containing the alkali metal include: alloys of an alkali metal and aluminum, lead, indium, potassium, cadmium, tin, magnesium, or the like; compounds of an alkali metal and a carbon material; compounds of an alkali metal of low electric potential and either a metal oxide or a sulfide; and the like.

When a carbon material is used for the negative electrode, the carbon material is preferably something that can be doped and undoped with lithium ions, possible examples of which include graphite, pyrolytic carbons, cokes, glassy carbons, sintered organic polymer compounds, meso carbon microbeads, carbon fibers, activated carbon, and the like.

For the negative electrode in the present embodiment, a carbon material 10 μm in average particle diameter was mixed into a solution consisting of vinylidene fluoride dissolved in N-methyl pyrrolidone to form a slurry, this negative electrode compound slurry was passed through a 70 mesh to remove large particles and then uniformly applied as a coating on both surfaces of a negative electrode current collector composed of a strip of copper foil 18 μm thick, the coating was dried, then press-molded by a roll press, and the result was cut into a strip-shaped negative electrode.

For the positive electrode, a metal oxide such as lithium cobalt oxide, lithium nickel oxide, lithium manganese oxide, manganese dioxide, vanadium pentoxide, or chromium oxide, and a metal sulfide such as molybdenum disulfide were used as active materials, a suitable amount of an electroconductive aid or a bonding agent or the like such as polytetrafluoroethylene was added to these positive electrode active materials, and the resulting compound was finished into a mold using a current-collecting material such as a stainless steel mesh as a core.

In the present embodiment, a strip-shaped positive electrode plate prepared in the following manner was used as the positive electrode. Specifically, phosphorous-like graphite was added in a mass ratio of (lithium cobalt oxide:phosphorous-like graphite) of 90:5 as an electroconductive aid and mixed with lithium cobalt oxide (LiCoO₂), and this mixture was mixed with a solution of polyvinylidene fluoride dissolved in N-methyl pyrrolidone to form a slurry. This positive electrode compound slurry was passed through a 70 mesh to remove large particles, and then uniformly applied as a coating on both surfaces of a positive electrode current collector composed of aluminum foil 20 μm thick, the coating was dried, then press-molded by a roll press, and the result was cut into a strip-shaped positive electrode.

### EXAMPLES

Examples and comparative examples are presented below and the manufacturing method of the present invention is described in further detail, but the present invention is not limited to these examples.

(Wrinkle Evaluation)

Wrinkles that formed in the laminated porous film during winding were evaluated by the following criteria.

⊚: No wrinkling observed by the naked eye

◯: Almost no wrinkling observed by the naked eye (within a practical range)

Δ: Little continuous wrinkling observed by the naked eye

x: Much continuous wrinkling observed by the naked eye, wrinkles in finished product

(Polyolefin-Based Resin Porous Film)

A polypropylene-based resin (Prime Polypro F300SV made by Prime Polymer Co., density: 0.90 g/cm³, MFR: 3.0 g/10 min) was prepared as the A layer, and 3,9-bis [4-(N-cyclohexyl carbamoyl) phenyl]-2,4,8,10-tetraoxaspiro [5.5] undecane was prepared as the β crystal nucleating agent. The raw materials were blended in a percentage of 0.2 parts by mass of the β crystal nucleating agent per 100 parts by mass of the polypropylene-based resin, the blend was put into a unidirectional twin-screw extruder (diameter: 40 mm□, L/D: 32) made by Toshiba Machine Co., Ltd. and melt-kneaded at a set temperature of 300° C., then strands were cooled and solidified in a water tank, the strands were cut by a pelletizer, and pellets of the polypropylene-based resin composition were produced. The β activity of the polypropylene-based resin composition was 80%.

Next, for the mixed resin composition constituting the B layer, 0.04 parts by mass of glycerin monoester and 10 parts by mass of microcrystalline wax (Hi-Mic 1080 made by Nippon Seiro Co., Ltd.) were added to 100 parts by mass of high-density polyethylene (Novatec HD HF560 made by Japan Polyethylene Corporation, density: 0.963 g/cm³, MFR: 7.0 g/10 min), and the mixture was melt-kneaded at 220° C. using the same unidirectional twin-screw extruder to obtain a resin composition processed into pellets.

Using the two previously described raw materials and separate extruders so that the outer layers were the A layer and the middle layer was the B layer, the raw materials were extruded by a layered-mold mouth piece through a two-type three-layer feed block and cooled and solidified by a 124° C. casting roller, and a two-type three-layer laminated membrane material consisting of an A layer, a B layer, and an A layer was prepared.

The laminated membrane material was stretched 4.6 times in the longitudinal direction using a longitudinal stretcher, and then stretched 1.9 times in the transverse direction at 98° C. by a transverse stretcher, after which a heat setting/slackening treatment was performed. As a result, a laminated porous film made of a polyolefin-based resin was obtained, having a film thickness of 20 μm and an air permeability of 450 sec/100 mL.

The resulting polyolefin-based resin porous film was subjected to a corona surface treatment using a corona treatment system (six two-ridged aluminum type 5 electrodes made by Kasuga Denki, Inc., line speed: 50 m/min, treatment output: 1.5 kW).

(Coating Solution for Heat-Resistant Layer)

A dispersion solution was obtained in which 39.2 parts by mass of alumina (Sumicorundum AA-03 made by Sumitomo Chemical Co., average particle diameter: 0.3 μm) and 0.8 parts by mass of polyvinyl alcohol (PVA 120 made by Kuraray Co., Ltd., degree of saponification: 98.0 to 99.0, average degree of polymerization: 2000) were dispersed in 60.0 parts by mass of water.

### Example 1

Using a small-diameter gravure roll (roll diameter 62 mm, gravure engraving: lattice QUADRA gravure(depth 290 μm, cell volume 145 cm³/m²)), a base material of the polyolefin-based resin porous film described above was coated with the coating solution described above to form a covering layer. The film tension (Ta) in the drying step was controlled to 29 N/m, and the film tension (Tb) in the winding step was controlled to 25 N/m. The values of Ta and Tb were measured by tension detectors connected to respectively corresponding tension pickup rollers.

### Example 2

Other than the film tension (Ta) in the drying step being controlled to 40 N/m and the film tension (Tb) in the winding step being controlled to 35 N/m, coating was performed in the same manner as Example 1.

### Example 3

Other than the film tension (Ta) in the drying step being controlled to 35 N/m and the film tension (Tb) in the winding step being controlled to 30 N/m, coating was performed in the same manner as Example 1.

### Example 4

Other than the film tension (Ta) in the drying step being controlled to 35 N/m and the film tension (Tb) in the winding step being controlled to 25 N/m, coating was performed in the same manner as Example 1.

### Example 5

Other than the film tension (Ta) in the drying step being controlled to 40 N/m and the film tension (Tb) in the winding step being controlled to 30 N/m, coating was performed in the same manner as Example 1.

### Comparative Example 1

Other than the film tension (Ta) in the drying step being controlled to 45 N/m and the film tension (Tb) in the winding step being controlled to 40 N/m, coating was performed in the same manner as Example 1.

### Comparative Example 2

Other than the film tension (Ta) in the drying step being controlled to 50 N/m and the film tension (Tb) in the winding step being controlled to 45 N/m, coating was performed in the same manner as Example 1.

### Comparative Example 3

Other than the film tension (Ta) in the drying step being controlled to 45 N/m and the film tension (Tb) in the winding step being controlled to 29 N/m, coating was performed in the same manner as Example 1.

Results of evaluating Examples 1 to 5 and Comparative Examples 1 to 3 are shown below.

TABLE 1

| | Ta of | | | |
|---|---|---|---|---|
| | drying | Tb of winding | \|Ta − Tb\| | |
| | step (N/m) | step (N/m) | (N/m) | Wrinkles |
| Example 1 | 29 | 25 | 4 | ⊚ |
| Example 2 | 40 | 35 | 5 | ◯ |
| Example 3 | 35 | 30 | 5 | ⊚ |
| Example 4 | 35 | 25 | 10 | ⊚ |
| Example 5 | 40 | 30 | 10 | ◯ |
| Comparative Ex. 1 | 45 | 40 | 5 | Δ |
| Comparative Ex. 2 | 50 | 45 | 5 | X |
| Comparative Ex. 3 | 45 | 29 | 16 | X |

As shown in Table 1, wrinkling can be suppressed by controlling the film tension (Ta) in the drying step and the film tension (Tb) in the winding step through the manufacturing method of the present invention. By controlling the values Ta, Tb, and |Ta−Tb| within the specified ranges, coating can be performed in a stable manner with no wrinkling.

1. A process for manufacturing a laminated porous film, comprising:
layering a covering layer on a surface of a polyolefin-based resin porous film by coating a resin solution comprising a filler wherein a filler and a resin binder are dissolved or dispersed in a solvent,
drying the laminated film wherein the covering layer is layered,
removing the solvent, and
winding the dried film,
wherein a film tension (Ta) in the drying is controlled at 40 N/m or less.

2. A process for manufacturing a laminated porous film, comprising:
layering a covering layer on a surface of a polyolefin-based resin porous film by coating a resin solution comprising filler wherein a filler and a resin binder are dissolved or dispersed in a solvent
drying the laminated film wherein the covering layer is layered,
removing the solvent, and
winding the dried film,
wherein a film tension (Ta) in the drying and a film tension (Tb) in the winding satisfiy the following expressions:
Ta≦40 N/m,
Tb≦40 N/m, and

|Ta—Tb|<10 N/m.

3-5. (canceled)

6. The process of claim 1, wherein after a surface of the polyolefin-based resin porous film has been treated, a covering layer is layered on a treated surface.

7. The process of claim 6, wherein in the surface treatment, a temperature of the film is controlled to be 50° C. or less.

8. The process of claim 7, wherein the temperature is controlled by cooling a support roll in the surface treatment.

9. The process of claim 8, wherein the temperature of the support roll is controlled at 50° C. or less.

10. The process of claim 7, wherein a wrap angle of the support roll in the surface treatment is controlled at 120 degrees or less.

11. The process of claim 7, wherein the support roll in the surface treatment is a metal roll.

12. The process of claim 7, wherein the surface treatment is selected from the group consisting of corona treatment, plasma treatment, plasma treatment under atmospheric pressure, flame plasma treatment, and UV treatment.

13-15. (canceled)

16. The process of claim 2, wherein after a surface of the polyolefin-based resin porous film has been treated, a covering layer is layered on a treated surface.

17. The process of claim 16, wherein in the surface treatment, a temperature of the film is controlled to be 50° C. or less.

18. The process of claim 17, wherein the temperature is controlled by cooling a support roll in the surface treatment.

19. The process of claim 18, wherein the temperature of the support roll is controlled at 50° C. or less.

20. The process of claim 17, wherein a wrap angle of the support roll in the surface treatment is controlled at 120 degrees or less.

21. The process of claim 17, wherein the support roll in the surface treatment is a metal roll.

22. The process of claim 17, wherein the surface treatment is selected from the group consisting of corona treatment, plasma treatment, plasma treatment under atmospheric pressure, flame plasma treatment, and UV treatment.

23. The process of claim 2, wherein the film tension (Ta) in the drying and the film tension (Tb) in the winding further satisfy the condition Ta>Tb.

24. The process of claim 1, wherein the resin binder is at least one selected from the group consisting of polyvinyl alcohol, polyvinylidene fluoride, styrene-butadiene rubber, carboxymethylcellulose, and polyacrylic acid.

25. The process of claim 2, wherein the resin binder is at least one selected from the group consisting of polyvinyl alcohol, polyvinylidene fluoride, styrene-butadiene rubber, carboxymethylcellulose, and polyacrylic acid.
